(19) United States
(12) Patent Application Publication
(10) Pub. No.: US 2002/0103912 A1
(43) Pub. Date: Aug. 1, 2002

(54) Method and arrangement providing a virtual continuous connection

(76) Inventor: Steffen Dalgard, Bekkestua (NO)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/996,688

(22) Filed: Nov. 30, 2001

(30) Foreign Application Priority Data
Dec. 1, 2000 (NO) 20006127

(51) Int. Cl. G06F 15/16

(52) U.S. Cl. 709/227

(57) ABSTRACT

The present invention is related to data communication networks using a modem and a telephone network e.g. ISDN, PSTN or GSM for interconnection between systems. A control logic is included in the layer 2 protocol which is closing the temporary connection on layer 2 each time a timer elapses and re-establishing it when a new subsequent message from layer 3 is transmitted. The timer is being reset each time a message is transmitted. However, seen from layer 3 the control logic in layer 2 provides a continuous connection even if the actual connection is alternating. Thus, unnecessary time spent in the telephone network when no data is being transmitted will be minimized.

### FIELD OF THE INVENTION

The present invention is related to data communication networks, and in particular a dial up solution in data communication networks using a protocol stack like TCP/IP.

### BACKGROUND OF THE INVENTION

The ability for a data communication network to communicate with other networks are almost always required. The chosen connection utilized in this communication is a balance between cost and need. For example, for some applications, a continuous, fixed connection, e.g. a cable exclusive for that purpose may be provided. FIG. 1 shows an example of such a connection between system A and system B, both using TCP/IP and PPP(Point to Point Protocol) divided into the four lowest layers of the OSI model. However, this is a quite expensive solution for long distances, and it is only defensible if the connection is in operation at nearly all times.

Thus, a circuit switched network, e.g. PSTN (Public Switched Telecommunication Network), or ISDN (Integrated Services Digital Network) used as interconnection medium may be more convenient. Virtual continuous connection is made by using dial up modems connected to and compatible for the actual telephone network. FIG. 2 shows the system of FIG. 1 wherein the fixed cable is replaced with a telephone network and a compatible modem.

This is an inefficient way of utilizing a telephone network which may result in unnecessary costs. There must be a dial up support in addition to a protocol stack (e.g. TCP/IP) and a layer 2 protocol (e.g. PPP).

In prior art, this dial up support is integrated in layer 3, e.g. the IP -layer (FIG. 3). Normally, the IP layer includes a forwarding table which has a logical connection between a destination address and the interface to which IP packets are sent. An example of such a table is shown in table 1.

TABLE 1
A forwarding table in an IP layer

| Network | | Use |
|---|---|---|
| address | Network mask | interface |
| 10.10.10.0 | 255.255.255.0 | PPP |
| 10.10.30.0 | 255.255.255.0 | ETH |
| 10.10.40.0 | 255.255.255.0 | PPP |

To extend this for dial out, the table also has a logical connection between a destination address and a telephone number. The telephone number is dialed when an IP-packet is forwarded. There may be more telephone numbers than modems, if not all connections need to be active at the same time.

TABLE 2
A forwarding table in an IP layer including telephone numbers

| Network | | |
|---|---|---|
| address | Network mask | Use number |
| 10.10.10.0 | 255.255.255.0 | 12345678 |
| 10.10.40.0 | 255.255.255.0 | 004612345678 |

The extended functionality is implemented as part of the IP layer (L3) (FIG. 3).

The problem with the above mentioned solution is that third party router stack implementations, e.g. TCP/IP, generally do not provide dial up support as an integrated part of the layer 3 implementation, e.g. IP layer implementation, and for an integration, a major redesign is necessary.

### SUMMARY OF THE INVENTION

It is an object of the present invention to provide an arrangement that eliminates the drawbacks described above. The features defined in the claims enclosed characterize this method.

More specifically, the present invention provides a method and an arrangement for connection between different communication systems through a telephone network. In an OSI layered system, the connection is established using a dial up modem compatible with the actual telephone system. A modem control logic is integrated in layer 2, and simulates a continuous connection towards layer 3.

### BRIEF DESCRIPTION OF THE DRAWINGS

In order to make the invention more understandable, the discussion that follows will refer to the accompanying drawings.

FIG. 1 shows a fixed cable connection between two systems using TCP/IP protocol stack and PPP layer 2 protocol.

FIG. 2 shows the two systems of FIG. 1 connected through a telephone network by using a modem compatible with the telephone network.

FIG. 3 shows system A of FIG. 1 connected to other systems by using a modem compatible with the telephone network including an extended dial up function integrated in the IP layer.

FIG. 4 is a closer view of system A according to the present invention with a modem control logic integrated in the PPP layer.

FIG. 5 shows system A according to the present invention; a modem control logic in the PPP layer, connected to system B through a telephone network.

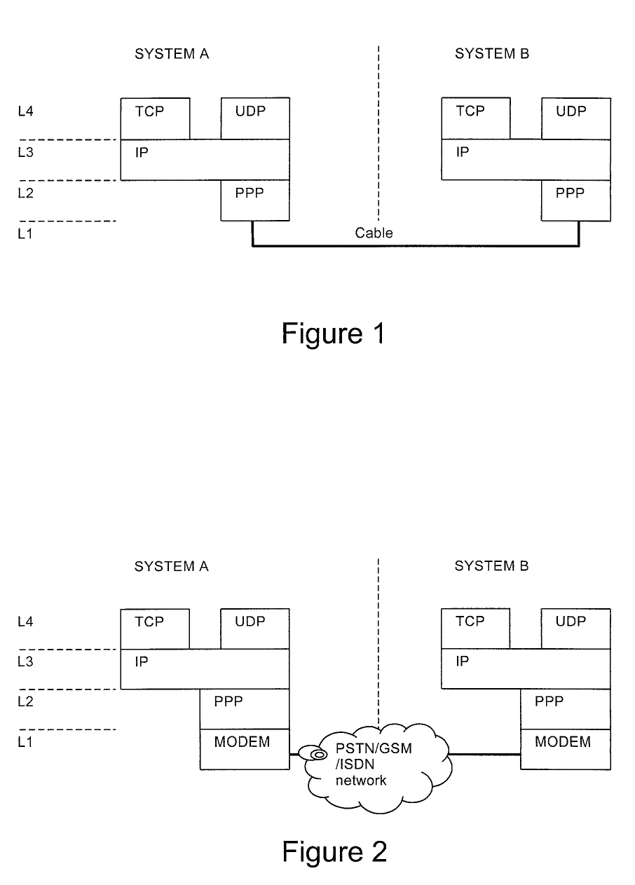

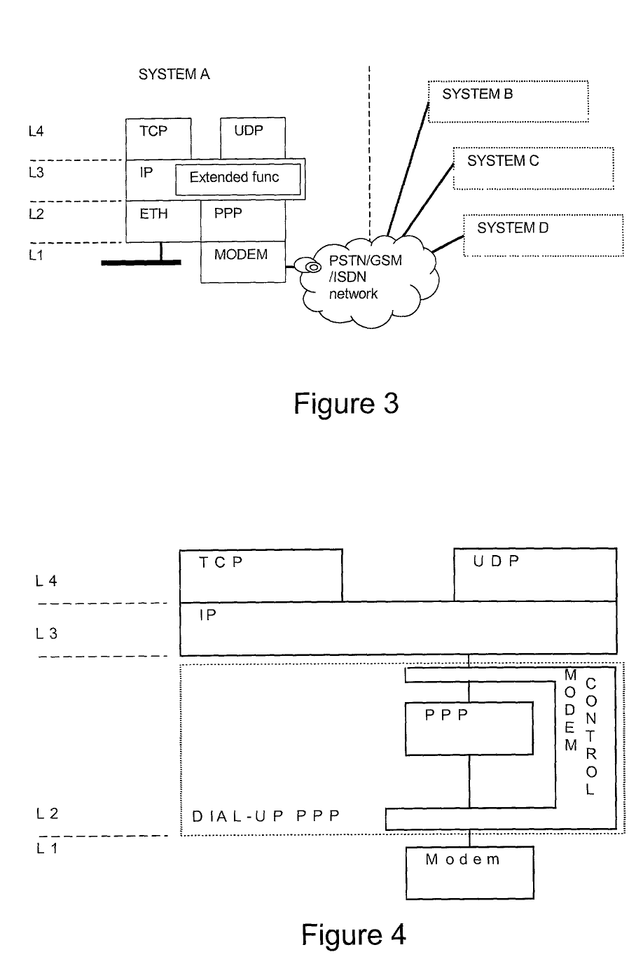

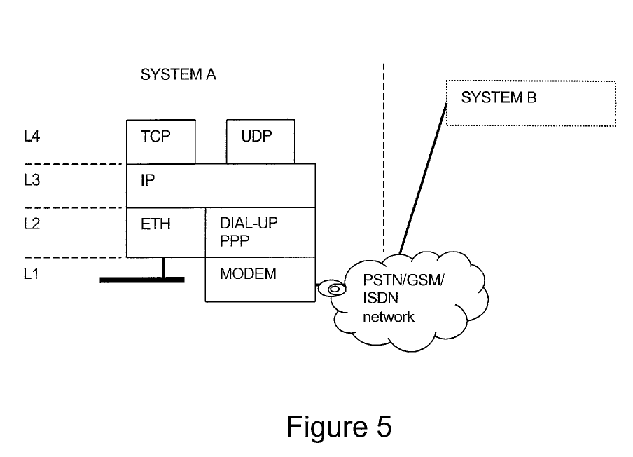

### AN EXAMPLE EMBODIMENT OF THE PRESENT INVENTION

The present invention will now be described in conjunction with an example embodiment. However, the present invention is not limited to this particular embodiment, but may be used in other applications with various substitutions without departing from the scope of the invention as defined in the enclosed claims.

In the example discussed, the system is divided into layers according to the OSI model wherein the protocols TCP, IP and PPP are used in layer 4 (L4) layer 3 (L3) and layer 2 (L2), respectively.

According to the present invention, all the dial up functionality is isolated in PPP (L2), and the IP (L3) may be left unchanged.

The original PPP (L2) function is extended with a modem control logic that hides the dial up functionality for IP (L3). This new extended PPP module is called “DIAL-UP PPP”, and simulate a continuous connection seen from the IP (L3).

“DIAL-UP PPP” (L2) provides a virtually continuous connection, because the dial-up functionality is not seen by IP (L3).

All messages to “DIAL-UP PPP” from IP are sensed by the modem control logic which initiates a dial out.

The modem control logic will have timers for closing the dial out connection if there are no more messages. The IP (L3) will still believe that there is an open connection to the destination of the last transmitted message. When a subsequent message belonging to the same virtual connection is transmitted from the IP layer, a new dial out will be required, but this will automatically be initiated by the modem control logic, and will not affect the IP (L3) or any of the upper layers.

For dial in, the call will be answered by the control logic, and the message is sent to IP by “DIAL-UP PPP”.

Since the upper layers is intended to experience this as a continuous connection, the same number has to be dialled every time within the same virtual connection.

Synchronisation with the remote PPP driver has to be done in a way that do not disturb the upper layers, so that the upper layer at any time will experience a continuous data connection.

### Abbreviations

ETH Ethernet

PPP Point to Point Protocol

TCP Transmission Control Protocol

UDP User Datagram Protocol

IP Internet Protocol

1. A method in a data communication network for virtual continuous connection between a first system to other systems in said data communication network, said first system divided into layers according to the Open System Interconnection (OSI), OSI layer 2 (L2) using a PPP protocol, OSI layer 3 and 4 (L3 and L4) using a TCP/IP protocol, said connection provided by a telephone network connected to said first system by a modem or similar means compatible with said telephone network, characterized in:
establishing said virtual continuous connection on L3 with a second system by means of a control logic integrated with said PPP protocol in L2 by establishing a temporary connection with said second system on L2,
closing said temporary connection when a timer in said control logic elapses, still maintaining said continuous connection,
re-establishing said temporary connection when a new message within said continuous connection is sent from L3 to L2,
executing incoming messages by means of said control logic and sending them to L3.

2. A method as defined in claim 1, characterized in that said establishment and reestablishment of said temporary connection comprising dial up to said second system by means of said modem or similar means through said telephone network.

3. A method as defined in any of the preceding claims, characterized in the step of resetting said timer each time a message is received from L3 to L2.

4. A method as defined in any of the preceding claims, characterized in that said control logic is installed in a driver in L2 connected to said modem or similar means.

5. A method as defined in any of the preceding claims, characterized in that said telephone network is a PSTN or an ISDN network.

6. An arrangement in a data communication network for virtual continuous connection between a first system to other systems in said data communication network, said first system divided into layers according to the Open System Interconnection (OSI), OSI layer 2 (L1) using a PPP protocol, OSI layer 3 and 4 (L3 and L4) using a TCP/IP protocol, said connection provided by a telephone network connected to said first system by a modem or similar means compatible with said telephone network, characterized in a control logic integrated with said PPP protocol in L2 for establishing said virtual continuous connection with said second system on L2 by means of a temporary connection, said control logic closing said temporary connection when a timer in said control logic elapses, still maintaining said virtual continuous connection, said control logic re-establishing said temporary connection when a new message within said continuous connection is sent from L3 to L2, said control logic executing incoming messages and transferring them to L3.

7. An arrangement as defined in claim 6, characterized in that said establishment and reestablishment of said temporary connection comprising dial up to said second system by means of said modem or similar means through said telephone network.

8. An arrangement as defined in claims 6 or 7, characterized in that the timer is adapted to be reset each time a message is received from L3 in L2.

9. An arrangement as defined in claims 6-8, characterized in that said control logic is installed in a driver in L2 connected to said modem or similar means.

10. A arrangement as defined in claims 6-9, characterized in that said telephone network is a PSTN or an ISDN network.
